(19) United States
(12) Patent Application Publication
(10) Pub. No.: US 2024/0020345 A1
(43) Pub. Date: Jan. 18, 2024

(54) SEMANTIC EMBEDDINGS FOR CONTENT RETRIEVAL

(71) Applicant: Meta Platforms, Inc., Menlo Park, CA (US)

(72) Inventors: Aleksandr Ulanov, Palo Alto, CA (US); Dinkar Jain, Menlo Park, CA (US); Nikita Igorevych Lytkin, Sunnyvale, CA (US); Apurva Jadhav, Mountain View, CA (US); Yanxi Pan, Fremont, CA (US); Shike Mei, Mountain View, CA (US)

(21) Appl. No.: 16/017,861

(22) Filed: Jun. 25, 2018

(51) Int. Cl. G06F 17/30

(52) U.S. Cl. CPC G06F 17/30867; G06F 17/30554; G06F 17/30601

(57) ABSTRACT

A system uses semantic analysis of text associated with content items to recommend content for display to a user. A subset of representative words from a content description are determined and a content embedding that models the content is generated using a combination of word embeddings associated with each of the representative words. User embeddings are generated using a combination of content embeddings for content that a user has had particular interactions with in a set period of time. Separate user embeddings may be generated to represent user interactions with different categories of content (e.g., travel, photography, apparel, comedy, etc.). The system uses the content embeddings and user embeddings as input to predictive functions which determine a candidate content item that a user is likely to interact with if the candidate content is displayed to the user.

### BACKGROUND

This disclosure relates generally to semantic analysis of content, and in particular to using word embeddings to capture semantic relatedness when determining content items to present to a user.

Online system users may browse through a variety of online content, such as products and articles. In many cases, the user might view multiple related or similar content items. For example, a user shopping for shoes may browse through products such as heels, sandals, sneakers, flats, and the like. To a human, it is often obvious from images and descriptions that these products are all semantically related. A computer system, however, does not capture the semantic relatedness of content that the user views. Thus, it can be difficult for a computer system to determine content that the user will be interested in based on content that the user has viewed in the past beyond merely inferring likely user interests indirectly by observing interaction patterns among many users and many content items.

### SUMMARY

A system generates semantic representations of users and content. The system uses the semantic representations to recommend content items for display to particular users. In one embodiment, a semantic representation of a content item may account for some or all words included in or descriptively accompanying the content item. For example, a content item relating to a physical object may be associated with a product description, user reviews, and other textual content that may be modeled using techniques such as word embeddings. User behavior may be similarly modeled based on products and other content items a user interacts with.

Use of semantic representations of users and content allows the system to better tailor content and product recommendations to the interests of a user. Rather than relying on inferences about content that similar users have viewed, the system can directly determine whether content is similar to content that a user has interacted with previously in view of content text and product descriptions. This approach also allows the system to better identify low-traffic content items that might not otherwise be recommended for display to users. The system can determine the relevance of such low-traffic content items based on accompanying textual descriptions without relying on past interactions users have had with the content.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 illustrates a process for generating a content embedding from textual content, in accordance with an embodiment.

FIG. 4A illustrates a process for generating user embeddings based on product descriptions, in accordance with an embodiment.

FIG. 4B illustrates using content embeddings and user embeddings to select content for display, in accordance with an embodiment.

FIG. 5 is a flowchart illustrating a process for recommending content for display to a user based on semantic representations of the content, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

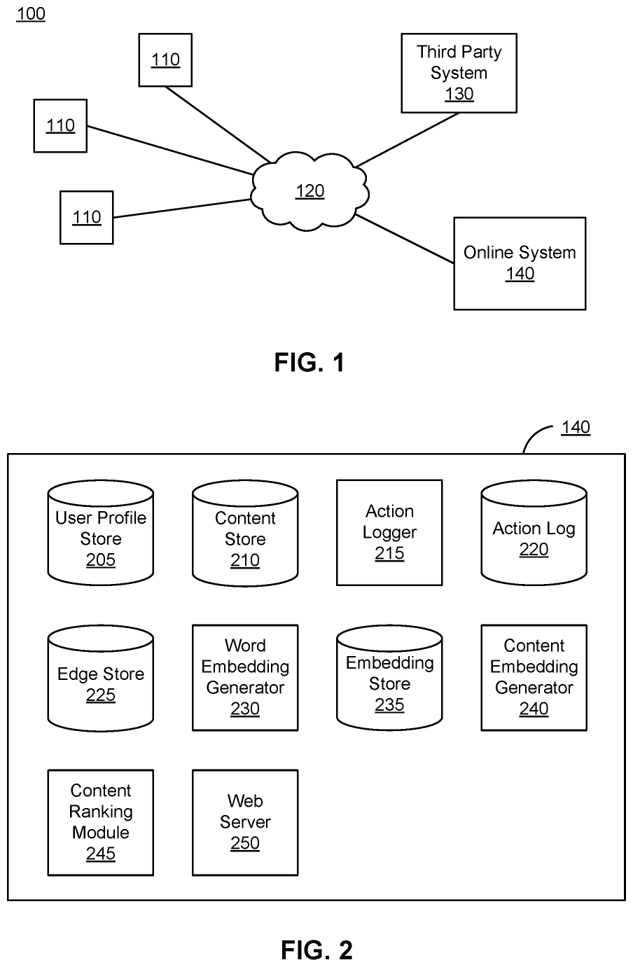

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

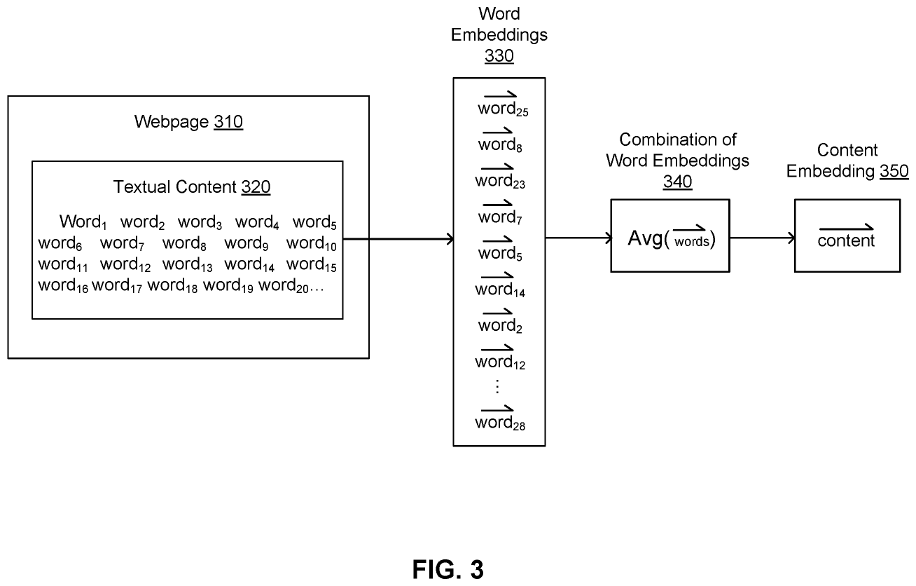

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a word embedding generator 230, an embedding store 235, a content embedding generator 240, a content ranking module 245, and a web server 250. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, a product and product description, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The word embedding generator 230 generates word embeddings that can be used to characterize content items and product descriptions that include text. An embedding is an array of values that describes an object in a multidimensional latent space. That is, each index in an array of an embedding can be thought of as a dimension, and the value at the index represents the value of the embedding in that dimension. Two embeddings are similar if they have similar values at each index. When visualizing the embeddings as vectors, such a similarity manifests in vectors that point in similar directions. A word embedding in particular, is an array of values that represents a word as it relates to other words. Thus, in generating word embeddings, the word embedding generator 230 embodies words as numerical vectors (i.e., arrays of values) in a latent space. The word embeddings are trained using a corpus of text documents. In one embodiment, the word embedding generator 230 is trained on a corpus of product descriptions and text related to content items stored in the content store 210. In another example embodiment, the word embedding generator 230 may train and use multiple models for generating word embeddings related to different categories of content. For example, the word embedding generator 230 may have one word embedding model trained on all product descriptions for products in the “apparel” category and may have another word embedding model trained on all product descriptions of products in the category of “travel.” Generating different word embeddings for use in different categorical contexts can help the online system 140 to more accurately identify the importance and meaning of words used in content descriptions. In other embodiments, the online system 140 can use pre-generated word embeddings (e.g., publically-available or trained via other document corpuses outside of the online system 140) rather than generating custom word embeddings with a word embedding generator 230.

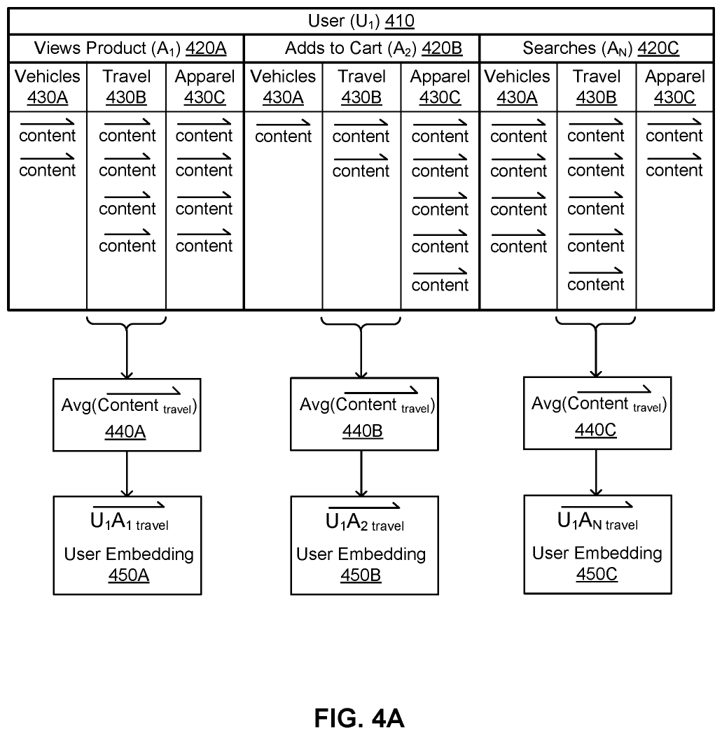

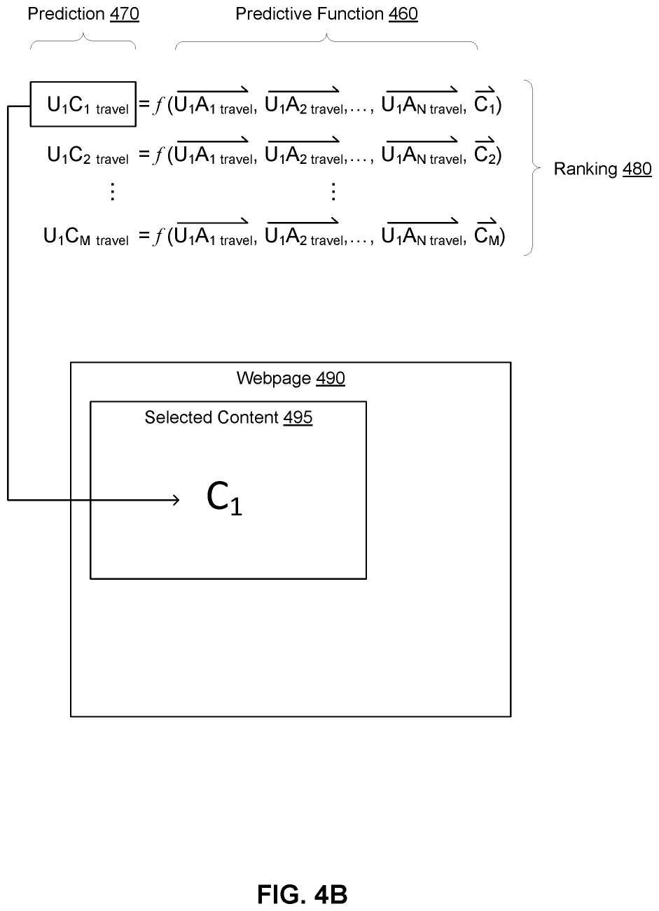

Word embeddings are stored in the embedding store 235. The embedding store 235 also stores other embeddings, such as the content embeddings generated by the content embedding generator 240 and the user embeddings which may be generated by the content ranking module 245. Additional information about the generation of different embeddings used by the online system 140 is included in the descriptions of FIG. 3 and FIG. 4A.

The content embedding generator 240 generates embeddings that represent content items. The embedding representations are based on text that is associated with the content items. For example, the content embedding generator 240 may generate a content embedding that represents a product using words from the product description. In one embodiment, such a content embedding is generated by combining some or all of the word embeddings of the words that make up the textual representation of the content item (e.g., a product description). Since embeddings are arrays of values, such a calculation might, for example, be an average or a weighted average of the vector values of the word embeddings. The content embedding generator 240 and the process for generating content embeddings are described in more detail with respect to FIG. 3.

The content ranking module 245 predicts the likelihood that a user will perform a conversion or other action with respect to a particular content item. In one embodiment, the content ranking module 245 provides content embeddings and user embeddings as inputs to a function that predicts a likelihood of an event given actions a user has taken in the past and given a content item or product that is a candidate for display. The content ranking module 245 may generate user embeddings based on content embeddings that represent content with which the user has previously interacted. In one embodiment, the content ranking module generates multiple user embeddings for a single user, such that each of the user embeddings represents a user's particular kind of interaction within a different categorization of content. For example, one user embedding may represent a user's searches for products within the apparel category, such as shirts and sweaters. In one example embodiment, a user embedding with respect to a particular interaction is based on a combination (e.g., average, weighted average, etc.) of the embeddings of content items the user has had that interaction with. The content embedding generator 240 and the content ranking module 245 may update the content embeddings and the user embeddings by regenerating the embeddings, for example, periodically, or when the online system 140 obtains new user or content data.

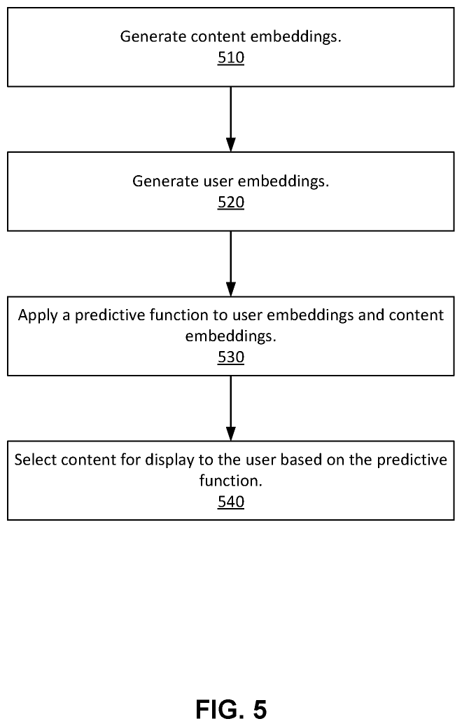

To determine what content item or product description should be displayed for a user, the content ranking module 245 applies a predictive function to the user embeddings of the user for a particular category. The predictive function may accept the user embeddings and a content embedding as input. The predictive function can generate a score that determines the likelihood of a conversion if the content is displayed to the user. In one embodiment, the likelihood scores of all candidate content items are ranked and the content item with the highest score is displayed to the user. Additional information about the content ranking module is described with respect to FIG. 5.

The web server 250 links the online system 140 via the network 120 to the one or more client devices 110, as well as to the one or more third party systems 130. The web server 250 serves web pages, as well as other content, such as JAVA®, FLASH®, XML and so forth. The web server 250 may receive and route messages between the online system 140 and the client device 110, for example, instant messages, queued messages (e.g., email), text messages, short message service (SMS) messages, or messages sent using any other suitable messaging technique. A user may send a request to the web server 250 to upload information (e.g., images or videos) that are stored in the content store 210. Additionally, the web server 250 may provide application programming interface (API) functionality to send data directly to native client device operating systems, such as IOS®, ANDROID™, or BlackberryOS.

FIG. 3 illustrates a process for generating a content embedding from textual content, in accordance with an embodiment. Some or all of the process shown in FIG. 3 may be performed by the content embedding generator 240. In many cases, a user interacts with content items on webpages 310. For example, when considering products for purchase, a user might view a webpage 310 with one or more products and accompanying textual content 320. Examples of textual content 320 include product descriptions, user reviews, articles, or any other text accompanying or associated with a content item. Textual content 320 comprises text that is associated with a content item (e.g., a product). In the example of FIG. 3, the text of the textual content 320 is depicted by variables “word₁, word₂, word₃” and so on. For example, a product description (e.g., textual content 320) for an item of clothing might include information about material, size, and fit, as well as testimonials or reviews from customers who purchased the product. Although examples used in this document sometimes describe products and product descriptions, this approach also applies to other content items that are displayed to a user with accompanying text. For example, the system can be applied as a recommendation system for recommending similar articles to a user based on the textual content 320 of previous articles that the user has read.

Word embeddings 330 for some or all of the words from the textual content 320 are obtained from the embedding store 235. The embedding store may include a generally trained set of word embeddings, or it may include word embeddings generated for specific categories.

In one embodiment, only a subset of the words of the textual content 320 are used to generate a content embedding 350. The online system 140 may better represent important concepts from the textual content 320 by disregarding words that are less relevant, for example, because they frequently occur in many different textual content 320 instances. In one embodiment, the content embedding generator 240 obtains the textual content 320 and tokenizes it into individual words. Each of the words from the textual content 320 is assigned a term frequency-inverse document frequency (TF-IDF) score that represents the importance of the word to the textual content 320 in view of the corpus of all available textual content 320, or in view of all of the instances of textual content 320 within the particular category of content. The content embedding generator 240 selects a predetermined number of the words from the product description that have the highest TF-IDF scores and accesses the word embeddings 330 for the top scoring words from the embedding store 235 for generating the content embedding 350. For example, the word embeddings 330 as depicted in FIG. 3, are associated with the highest scoring words from the textual content 320, and are sorted by TF-IDF score.

The content embedding generator 240 generates a content embedding 350. In one embodiment, as shown in FIG. 3, the content embedding 350 may be a combination 340 of the selected word embeddings 330, such as an average, weighted average, or sum. Thus, since the content embedding 350 is a combination of word embeddings 330, the content embedding 350 is a representation of the textual content 320. The content embeddings 350 generated by the content embedding generator 240 may be stored in the embedding store 235.

FIG. 4A illustrates a process for generating user embeddings based on product descriptions, in accordance with an embodiment. FIG. 4A includes a chart showing actions 420 that a user 410 has taken with respect to content items. In the example of FIG. 4A, the user interactions are further organized by category 430. For example, FIG. 4A depicts the content items (e.g., products) that the user 410 has added to an online shopping cart 420B for three categories of content including vehicles 430A, travel 430B, and apparel 430C. In other embodiments, user information may be stored in different configurations and may include additional or different actions 420 and categories 430.

In one embodiment, the content ranking module 245 generates user embeddings 450 by determining a combination 440 (e.g., an average) of the content embeddings 350 that are associated with content items (e.g., products) that the user has interacted with. That is, rather than characterizing the user directly with how a user's interactions may co-occur relative to other users' interactions (e.g., when a user's embedding is determined based directly on a set of users' interactions with a set of content items), in this example the user is indirectly represented through the embeddings of the content items with which the user has interacted. The content ranking module 245 may obtain the content embeddings from the embedding store 235. Multiple user embeddings 450 may be generated for a single user 410. The multiple user embeddings 450 may be representative of different actions 420 the user takes within different categories 430. For example, FIG. 4A depicts three user embeddings 450 that are generated by the content ranking module 245 that represent the user 410 in view of the user's interactions with content in the travel category 430B. The user embedding 450A represents content items from the travel category 430B that the user 410 has viewed 420A. The user embedding 450B represents content items from the travel category 430B that the user 410 has added to a cart 420B. Finally, the user embedding 450C represents content items from the travel category 430B that the user 410 has searched for 420C. In some embodiments, the content embeddings 350 that are used to generate a user embedding 450 are limited by timeframe in addition to being selected by category. For example, a user embedding 450B may be generated using content embeddings 350 for content that the user 410 added to a cart 420B within a prior time period, e.g., within the last two weeks.

FIG. 4B illustrates using content embeddings and user embeddings to select content for display, in accordance with an embodiment. The content ranking module 245 ranks candidate content items to determine which will be displayed to a user. For example, a webpage 490 may have one available advertising slot for which a set of candidate product advertisements in the travel category are competing. In one embodiment, the content ranking module 245 generates a ranking 480 by applying a predictive function 460 to content embeddings 350 of each of the candidate content items. Inputs to the predictive function 460 may include user embeddings 450 of the user 410 to whom the selected content is to be displayed and the content embedding 350 of a candidate content item. In some embodiments, the predictive function 460 can also accept other types of input parameters. Examples of additional input parameters can include user or content characterizations, such as embeddings in other latent spaces that characterize the content and the user according to co-occurrences of interactions.

The predictive function 460 generates a prediction 470 for each of the candidate content items. Depending on the implementation, the predictive function may generate predictions 470 representative of a user 410 performing different actions when presented with a content item. For example, the predictive function 460 may predict a likelihood that the user 410 will click on the content or the predictive function 460 may predict a likelihood that the user 410 will perform some conversion with respect to the content, such as purchasing a product that is advertised by the content. The content item with the best prediction 470 in the ranking 480 of content items may be selected as content 495 to be displayed on the webpage 490 when it is presented to the user 410.

The predictive function 460 may be a pre-programmed algorithm or may be an algorithm that is trained using computer modeling. As one example embodiment, the predictive function 460 may be a function that calculates the cosine similarities between the user embeddings 450 and a content embedding 350, to determine the proximity of the content embedding 350 to the user embeddings within the latent space (wherein close embeddings produce a higher likelihood of user interaction). In another example embodiment, a computer model may be trained to produce prediction values when given the user embeddings 450 and a content embedding 350 as input. Training data may comprise user embeddings 45, content embeddings 350, and validation data about whether the user actually interacted with the content item.

FIG. 5 is a flowchart illustrating a process for recommending content for display to a user based on semantic representations of the content, in accordance with an embodiment. The online system 140 generates 510 content embeddings 350 that represent content items. The content embeddings 350 represent text that is associated with the content or that describes the content. In one embodiment, the online system 140 generates content embeddings 350 by combining word embeddings of words that are included in the content descriptions. Content embeddings 350 may be generated for content that a user has interacted with in the past, for candidate content items that are candidates for display to a user, or for any content that is available for analysis by the online system 140.

The online system 140 also generates 520 user embeddings. The user embeddings 450 may be generated by combining information from content embeddings 350 with which a user has interacted. Multiple user embeddings 450 may be associated with a single user. In particular, a user embedding 450 may be representative of a certain type of user interaction with a specific categorization of content. Furthermore, a user embedding 450 may be generated using content embeddings 350 related to content items the user has interacted with in a bounded period of time (e.g., the last two weeks).

A predictive function is applied 530 to content embeddings 350 and user embeddings 450. The predictive function determines a likelihood of a user interacting with a particular content item. For example, the predictive function may predict a likelihood that the user will click on a content item when it is displayed to that user. In one embodiment, the online system 140 applies such a predictive function for a set of content items and determines the content item with which the user is most likely to interact by comparing the outputs of the predictive function. The online system 140 selects 540 a content item for display to the user.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A computer-implemented method for determining a content item to display to a user from among a set of candidate content items that includes a content item that has not been displayed to any user previously, the method comprising:
generating a set of content embeddings, each content embedding representative of a content item that includes a textual description of a product, wherein generating each content embedding comprises:
identifying a set of words included in the description of the product;
identifying a word embedding for each word in the set of words; and
determining an embedding for the content item based on a combination of the identified word embeddings of a subset of the words in the set of words;
generating a set of user embeddings for a user, wherein generating each of the set of user embeddings comprises:
identifying a set of content items associated with products on which the user has performed an action;
identifying, from among the generated set of content embeddings, a content embedding for each content item in the identified set of content items associated with products; and
generating the user embedding by combining the identified content embeddings wherein combining the identified content embeddings comprises generating an average of the identified content embeddings;
determining, using a predictive function that accepts as input the generated content embeddings and the generated user embeddings as input, a value for each content item, the value indicative of a likelihood that the user will interact with the product described in the content item; and
displaying the content item with the value indicating a highest likelihood that the user will interact with the product described in the content item to the user.

2. The computer-implemented method of claim 1, further comprising:
receiving the set of content items that are candidates for display to a user on a webpage.

3. The computer-implemented method of claim 1, further comprising generating a second plurality of user embeddings associated with a second category of content.

4. The computer-implemented method of claim 1, wherein the set of content items associated with products on which the user has performed the action is limited to content items associated with products on which the user has performed the action in a limited prior time period.

5. The computer-implemented method of claim 1, wherein determining a value for each content item with which the user is likely to interact comprises:
for each candidate content item from a set of content items that are candidates for display to the user on a webpage:
providing, as an input to the predictive function, a content embedding that represents the candidate content item;
providing, as input to the predictive function, at least one user embedding of the user; and
receiving, from the predictive function, a likelihood that the user will perform a conversion with respect to the product described in the content item if the content item is displayed to the user.

6. The computer-implemented method of claim 1 wherein inputs to the predictive function further comprise embeddings that represent co-occurrences of interactions between the user and products described in other content items.

7. (canceled)

8. A non-transitory computer-readable storage medium storing computer program instructions for determining a content item to display to a user from among a set of candidate content items that includes a content item that has not been displayed to any user previously, the instructions executable by one or more processors of a system to perform steps comprising:
generating a set of content embeddings, each content embedding representative of a content item that includes a textual description of a product, wherein generating each content embedding comprises:
identifying a set of words included in the description of the product;
identifying a word embedding for each word in the set of words; and
determining an embedding for the content item based on a combination of the identified word embeddings of a subset of the words in the set of words;
generating a set of user embeddings for a user, wherein generating each of the set of user embeddings comprises:
identifying a set of content items associated with products on which the user has performed an action;
identifying, from among the generated set of content embeddings, a content embedding for each content item in the identified set of content items associated with products; and
generating the user embedding by combining the identified content embeddings wherein combining the identified content embeddings comprises generating an average of the identified content embeddings;
determining, using a predictive function that accepts as input the generated content embeddings and the generated user embeddings as input, a value for each content item, the value indicative of a likelihood that the user will interact with the product described in the content item; and
displaying the content item with the value indicating a highest likelihood that the user will interact with the product described in the content item to the user.

9. The non-transitory computer-readable storage medium of claim 8, the steps further comprising:
receiving the set of content items that are candidates for display to a user on a webpage.

10. The non-transitory computer-readable storage medium of claim 8, the steps further comprising generating a second plurality of user embeddings associated with a second category of content.

11. The non-transitory computer readable storage medium of claim 8, wherein the set of content items associated with products on which the user has performed the action is limited to content items associated with products on which the user has performed the action in a limited prior time period.

12. The non-transitory computer-readable storage medium of claim 8, wherein determining a value for each content item with which the user is likely to interact comprises:
for each candidate content item from a set of content items that are candidates for display to the user on a webpage:
providing, as an input to the predictive function, a content embedding that represents the candidate content item;
providing, as input to the predictive function, at least one user embedding of the user; and
receiving, from the predictive function, a likelihood that the user will perform a conversion with respect to the product described in the content item if the content item is displayed to the user.

13. The non-transitory computer-readable storage medium of claim 8 wherein inputs to the predictive function further comprise embeddings that represent co-occurrences of interactions between the user and products described in other content items.

14. The non-transitory computer-readable storage medium of claim 8, wherein determining an embedding for the content item based on a combination of the identified word embeddings comprises generating an average of the embedding arrays of the identified word embeddings.

15. A computer system comprising:
one or more computer processors for executing computer program instructions for determining a content item to display to a user from among a set of candidate content items that includes a content item that has not been displayed to any user previously; and
a non-transitory computer-readable storage medium storing instructions executable by the one or more computer processors to perform steps comprising:
generating a set of content embeddings, each content embedding representative of a content item that includes a textual description of a product, wherein generating each content embedding comprises:
identifying a set of words included in the description of the product;
identifying a word embedding for each word in the set of words; and
determining an embedding for the content item based on a combination of the identified word embeddings of a subset of the words in the set of words;
generating, a set of user embeddings for a user, wherein generating each of the set of user embeddings comprises:
identifying a set of content items associated with products on which the user has performed an action;
identifying, from among the generated set of content embeddings, a content embedding for each content item in the identified set of content items associated with products; and
generating the user embedding by combining of the identified content embeddings wherein combining the identified content embeddings comprises generating an average of the identified content embeddings;
determining, using a predictive function that accepts as input the generated content embeddings and the generated user embeddings as input, a value for each content item, the value indicative of a likelihood that the user with interact with the product described in the content item; and
displaying the content item with the value indicating a highest likelihood that the user will interact with the product described in the content item to the user.

16. The computer system of claim 15, the steps further comprising:
receiving the set of content items that are candidates for display to a user on a webpage.

17. The computer system of claim 15, the steps further comprising generating a second plurality of user embeddings associated with a second category of content.

18. The computer system of claim 15, wherein the set of content items associated with products on which the user has performed the action is limited to content items associated with products on which the user has performed the action in a limited prior time period.

19. The computer system of claim 15, wherein determining an embedding for the content item based on a combination of the identified word embeddings comprises generating an average of the embedding arrays of the identified word embeddings.

20. The computer system of claim 15, wherein determining a value for each content item with which the user is likely to interact comprises:
for each candidate content item from a set of content items that are candidates for display to the user on a webpage:
providing, as an input to the predictive function, a content embedding that represents the candidate content item;
providing, as input to the predictive function, at least one user embedding of the user; and
receiving, from the predictive function, a likelihood that the user will perform a conversion with respect to the product described in the content item if the content item is displayed to the user.
